(19) United States
(12) Patent Application Publication
(10) Pub. No.: US 2006/0023896 A1
(43) Pub. Date: Feb. 2, 2006

(54) Apparatus and method for controlling output signals from an amplifier when changing state

(76) Inventors: Mark G. Ginsberg, Blue Ridge, TX (US); Edwin Suryahusada, Richardson, TX (US); Donald A. Dapkus, Dallas, TX (US)

Correspondence Address: TEXAS INSTRUMENTS INCORPORATED, P O BOX 655474, M/S 3999, DALLAS, TX, 75265, US

(21) Appl. No.: 10/902,656

(22) Filed: Jul. 28, 2004

(51) Int. Cl. H04B 15/00

(52) U.S. Cl. 381/94.8; 381/120; 381/94.5

(57) ABSTRACT

An apparatus for controlling output signals from an amplifier when changing state; the amplifier having input loci, output loci and a state locus, and changing state in response to a state controlling signal received at the state locus; includes: (a) a state sensing circuit coupled with the state locus that provides a state signal in response to the state controlling signal; (b) an input level unit coupled with the state sensing circuit and with a selected input locus, and setting a first input signal level at the selected input locus when the amplifier changes from a first state to a second state; and (c) an output level unit coupled with the state sensing circuit and with a selected output locus, and setting a first output signal level at the selected output locus when the amplifier changes from the first state to the second state.

### CROSS REFERENCE TO RELATED APPLICATIONS

This application claims priority under 35 U.S.C. § 119(e) of U.S. Provisional Patent Application No. 60/589,197 filed Jul. 19, 2004 and entitled “POP REDUCTION FOR THE TPA1517 AUDIO POWER AMPLIFIER”, the disclosure of which is hereby incorporated by reference herein.

### BACKGROUND OF THE INVENTION

The present invention is directed to signal amplifiers, and especially to signal amplifiers exhibiting significant signal variation at at least one of their input or output loci when changing state. The present invention may be advantageously employed in any signal amplifier, including by way of example and not by way of limitation, audio amplifiers having monaural or stereo inputs or outputs, signal amplifiers having single ended or differential inputs and signal amplifiers having single ended or bridge tied outputs.

The invention will be described herein generally in terms of an audio amplifier. However, those skilled in the art of signal amplifier design will recognize the advantages of using the present invention with other signal amplifiers as well.

The pop heard when an audio amplifier changes state, such as when it comes in and out of shutdown or standby or when it is simply powered on and off, can directly affect the enjoyment a listener experiences when they turn on an audio device such as a television, stereo, powered speakers, walkman, or another audio device. The phenomenon is usually manifested as a thud, crack or pop heard when turning on a radio or television or turning on powered speakers for a computer. Such noises are commonly considered a nuisance that may even be overlooked or forgotten over time, so long as the annoying sound is relatively mild. In certain circumstances, the pop can be so loud as to cause irritation, agitation or even physical discomfort to the ear.

There is a need for an apparatus and method that can eliminate or significantly reduce the amount of pop, or unwanted noise, that is produced by a speaker (or is manifested in other output by a signal amplifier) and thus to a listener's ear.

### SUMMARY OF THE INVENTION

An apparatus for controlling output signals from an amplifier when changing state; the amplifier having input loci, output loci and a state locus, and changing state in response to a state controlling signal received at the state locus; includes: (a) a state sensing circuit coupled with the state locus that provides a state signal in response to the state controlling signal; (b) an input level unit coupled with the state sensing circuit and with a selected input locus, and setting a first input signal level at the selected input locus when the amplifier changes from a first state to a second state; and (c) an output level unit coupled with the state sensing circuit and with a selected output locus, and setting a first output signal level at the selected output locus when the amplifier changes from the first state to the second state, and second state to the first state.

It is, therefore, an object of the present invention to provide an apparatus and method that can eliminate or significantly reduce the amount of pop, or unwanted noise, that is produced by a speaker, or is manifested in other output by a signal amplifier.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is an electrical schematic diagram of an audio amplifier with the apparatus of the present invention installed using bipolar junction transistor technology.

FIG. 2 is an electrical schematic diagram of an audio amplifier with the apparatus of the present invention installed using metal oxide silicon (MOS) transistor technology.

FIG. 3 is an electrical schematic diagram of a signal amplifier with the apparatus of the present invention installed using bipolar junction transistor technology.

FIG. 4 is an electrical schematic diagram of a signal amplifier with the apparatus of the present invention installed using metal oxide silicon (MOS) transistor technology.

FIG. 5 is a flow chart illustrating the method of the present invention.

### DETAILED DESCRIPTION OF THE PREFERRED EMBODIMENT

The noise addressed in this exemplary description of the apparatus of the invention is undesirable noise heard when an audio amplifier is taken out of standby mode. This undesirable noise is commonly manifested as a distinct, sometimes annoyingly loud pop.

The pop heard when the amplifier is put into standby mode is usually less than is experienced when taking the amplifier out of standby mode. The pop is caused by two events happening substantially simultaneously: the input loci of the amplifier are biasing up to the amplifier's operational level, and a change is experienced in the output bias level at the amplifier's output loci. These changes—biasing up of the input loci and bias changes at the output loci—are substantially sudden. That is, substantial amplitude changes are experienced in short time intervals.

When the amplifier is placed into standby mode, the input DC (direct current) bias voltage will drop, often by several hundred millivolts or more. The representative parametric values discussed here are appropriate for a representative audio amplifier; they are presented by way of illustration and not by way of limitation. When the amplifier is returned to an active state from the standby state, the input bias voltage quickly returns to its nominal or operating level, say at 2.1 Volts. The farther away from the operating voltage (i.e., in this example 2.1 Volts) the input bias voltage rests in the standby mode, the louder the pop will be as the input voltage quickly returns to its operating level.

The DC (direct current) bias at the outputs of the amplifier are typically established at V_{CC}/2 is the supply voltage for the amplifier). This is commonly established as the preferred DC output bias so that the output signal can have a high output swing in both the positive and negative directions without one side being clipped before the other. Some audio amplifiers are configured so that when they are placed into standby mode, their outputs do not go to ground. Rather, the outputs in those amplifiers usually remain at the DC output bias level. During the transition from standby state to an active or on state, the output loci can exhibit brief but sharp transient spikes in DC voltage. These spikes, which can be several volts in magnitude, propagate to the speaker cause a loud pop sound. This occurs because the voltage variation is so quick that the DC blocking capacitors (usually employed to block DC at the outputs) fail to see this as a change in DC, and therefore allow the signal to pass through to the speakers. In BTL (bridge-tied load) amplifier configurations, an additional cause of noise or pop can be caused by a mismatch of the output DC bias voltage of the positive and negative outputs, resulting in a large flow of DC current through the speaker.

One can observe that pop is caused by DC bias issues at the inputs and outputs of an amplifier. In order to minimize the occurrence and magnitude of pop as much as possible it is necessary to find a solution that will work with both the input and output DC bias causations. This, essentially, amounts to two separate solutions, since either one can be used individually.

The DC input bias problem is not as big a contributor to pop as the output DC bias, but input DC bias is more complicated. Since pop generated by input DC bias voltage is caused by a significant drop in the input DC bias voltage when the amplifier goes into standby state or mode from an active or on state or mode, one solution may be to force the inputs to their operating voltage regardless of the state of the device.

This solution is not as simple as it would at first appear to be. Simply putting a resistor divider at the inputs to generate the operating voltage desired on the input pins from the supply voltage is not a good solution. That solution will provide the constant DC bias required, but it will also require that two resistors be permanently placed on the device side of the input capacitor. This has the deleterious effect of significantly attenuating the input signal.

What is required is a solution in which the input DC bias voltages are provided by an external source when the amplifier is in a standby or not-on state, but where the external components are disconnected during normal operation. To accomplish this, a series of switches are preferably used in conjunction with a resistor divider sized appropriately for developing the desired operating voltage from the supply voltage. A first switch is connected to the STATE pin at which is received a state controlling signal for setting the state of the amplifier. The first switch acts as an inverter. A second switch is provided to connect or disconnect the INPUT pin from the operating voltage developed by the resistor divider.

Some amplifiers have a relatively large input bias current. For such amplifiers it is advantageous to use resistors of lower values in the resistor divider. This is so that the input bias current has as little effect as possible on the operating voltage developed by the resistor divider. Using resistors whose total series value too great is unwise because the operating voltage will get pulled around by the input bias current of the device itself. However, using too low a resistive value can result in high current through the resistor divider which can generate unwanted heat.

The impact on pop by transients at amplifier output loci is significant. The solution to the pop caused by the output transients is to pull the output loci to ground when the device goes into standby or other not-on state. When the amplifier returns to an on state from a not-on state (e.g, a standby state), one should very quickly (but not instantaneously) bring the output loci back up to the desired potential (e.g., midrail, or V_{CC}/2) when the amplifier returns to an on or active state.

When the output loci are intentionally brought to ground, their potential cannot violently move around when the device first returns to active mode. When the switches connecting the output loci to ground open, the output loci may return to their operating DC bias level (e.g., V_{CC}/2) and be able to drive speakers

Both the inputs and outputs must have the proper treatment in order for the pop solution to be most beneficial. Some amplifiers are stereo amplifiers, so their treatment for reducing pop may be configured to work for both stereo channels (left channel and right channel) with a minimal component count. This can be accomplished using the present invention by using just one inverter to control input level setting for both the left and right channel input loci, and to control input level setting for both left and right channel output loci.

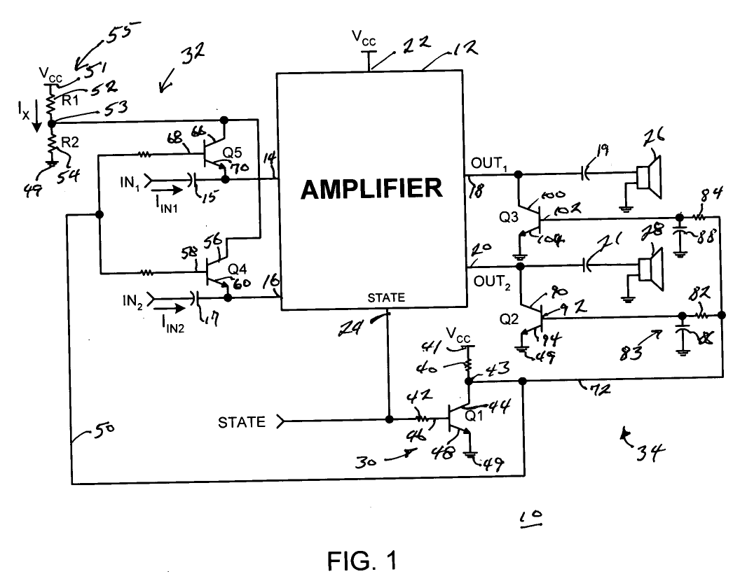

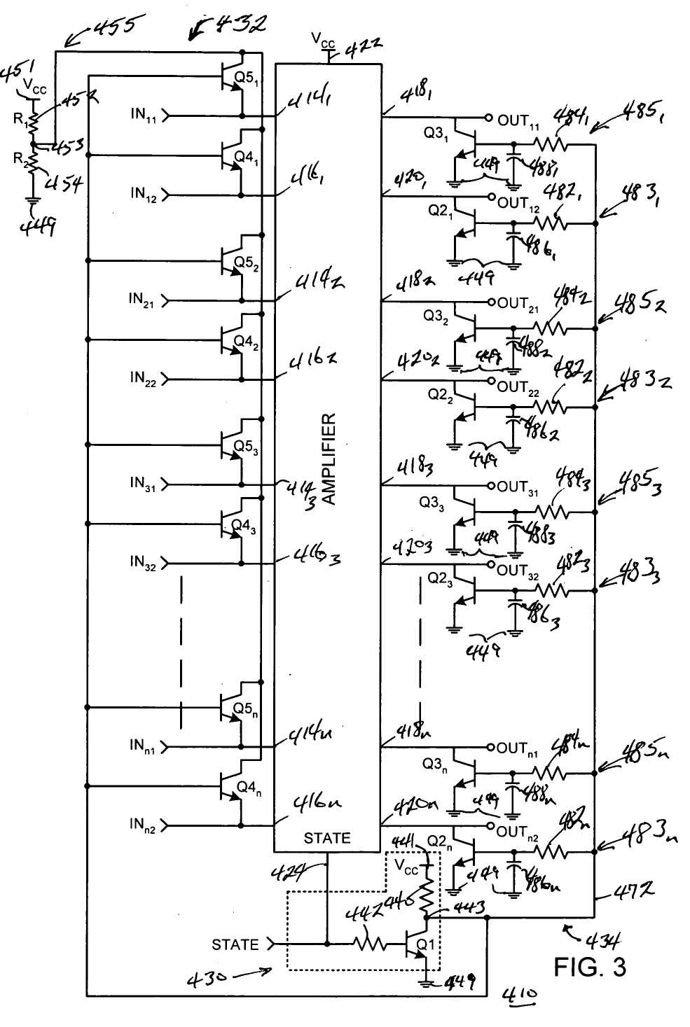

In the configurations illustrated in FIGS. 1-4, the state control signal STATE is pulled to ground for a low to impose a not-on or standby state on the amplifier. This convention is particularly advantageous in circuits employing bipolar junction transistor technology (FIGS. 1 and 3) in that it will ensure that variations in V_{BE} (base-to-emitter voltage) in various bipolar transistors in the circuit do not accidentally activate the circuit.

The pop reduction solution disclosed in this application can also be used to lessen the effects of a power up and power down sequence for any amplifier. During operation, some audio amplifiers are subject to loud pops during power up and power down sequences. The pop reduction apparatus and method of the present invention can be adapted to overcome this annoyance as well. Left alone, the pop reduction circuitry of the present invention may not help much during power up and power down because power is being removed from the pop reducing circuitry as well as the device. Preferably the amplifier can be powered up and powered down in a standby mode or state (and set to an on or not on state after completion of the powering up or powering down is complete) so that the pop reducing circuitry may be provided enough time to properly bias the inputs and outputs of the amplifier. By powering the amplifier up and down in a standby mode or state, when the amplifier is placed into an active state, pop is significantly reduced. Further, the pop reducing circuitry can hold the output to ground when in standby mode, so that when the device is powered off, it will exhibit virtually no pop.

FIG. 1 is an electrical schematic diagram of an audio amplifier with the apparatus of the present invention installed using bipolar junction transistor technology. In FIG. 1, a noise or pop reducing apparatus 10 is illustrated installed with an amplifier 12. Amplifier 12 is an audio amplifier in this exemplary description of the apparatus of the present invention. Amplifier 12 has a plurality of connection loci, all of which are not shown in FIG. 1. Only those connection loci of amplifier 12 that pertain to explaining the present invention are illustrated in FIG. 1. Amplifier 12 has an input locus 14 at which is received a first input signal IN₁ and has an input locus 16 at which is received a second input signal IN₂. Amplifier 12 has an output locus 18 at which is presented a first output signal OUT₁ and has an output locus 20 at which is presented a second output signal OUT₂. Amplifier 12 has a voltage supply locus 22 at which is received a supply voltage V_{CC}, and amplifier 12 has a state controlling signal locus 24 at which is received a state controlling signal STATE.

Apparatus 10 includes a state sensing circuit 30, an input level setting unit 32 and an output level setting unit 34. State sensing circuit 30 includes an NPN bipolar transistor Q1 and resistors 40, 42. Transistor Q1 has a collector 44, a base 46 and an emitter 48. Resistor 40 is coupled between a supply voltage locus 41 and collector 44. Resistor 42 is coupled between base 46 and state controlling signal locus 24. Emitter 48 is coupled with ground 49. Supply voltage V_{CC} is provided at supply voltage locus 41.

Input level setting unit 32 is coupled via a line 50 with state sensing circuit 30 at a connection locus 43 between resistor 40 and collector 44. Input level setting unit 32 includes resistors 52, 54 and NPN bipolar transistors Q4, Q5. Transistor Q4 has a collector 56, a base 58 and an emitter 60. Transistor Q5 has a collector 66, a base 68 and an emitter 70. Resistors 52, 54 establish a voltage divider circuit 55 between a supply voltage locus 51 and ground 49. Resistor 52 is coupled between supply voltage locus 51 and a connection locus 53. Resistor 54 is coupled between connection locus 53 and ground 49. Supply voltage V_{CC} is provided at supply voltage locus 51. Collectors 56, 66 are coupled with connection locus 53. Emitter 60 is coupled with input locus 16. Emitter 70 is coupled with input locus 14. Bases 58, 68 are coupled with connection locus 43 via line 50. Capacitors 15, 17 serve as DC (direct current) blockers for signals applied at input loci 14, 16.

Output level setting unit 34 is coupled via a line 72 with state sensing circuit 30 at connection locus 43. Output level setting unit 34 includes resistors 82, 84, capacitors 86, 88 and NPN bipolar transistors Q2, Q3. Transistor Q2 has a collector 90, a base 92 and an emitter 94. Transistor Q3 has a collector 100, a base 102 and an emitter 104. Resistor 82 and capacitor 86 coupled among connection locus 43, base 92 and ground 49 to establish an RC (resistor-capacitor) time constant circuit 83 that delays signal changes at connection locus 43 from arriving at base 92 for a predetermined time interval. Resistor 84 and capacitor 88 coupled among connection locus 43, base 102 and ground 49 to establish an RC time constant circuit 85 that delays signal changes at connection locus 43 from arriving at base 102 for a predetermined time interval. Preferably the time intervals for delay are substantially similar for RC time constant circuits 83, 85.

Emitters 94, 104 are coupled with ground 49. Collector 90 is coupled with output locus 20. Collector 100 is coupled with output locus 18. Base 92 is coupled with connection locus 43 via RC time constant circuit 83 and line 72. Base 102 is coupled with connection locus 43 via RC time constant circuit 85 and line 72. Capacitors 19, 21 serve as DC (direct current) blockers for signals provided to speakers 26, 28.

When amplifier 12 is placed in a not-on or standby state, state controlling signal STATE goes low, thereby turning off transistor Q1. Turning off transistor Q1 disconnects connection locus 43 from ground 49 and permits potential at connection locus 43 to rise to a voltage substantially equal with V_{CC} less a voltage drop across resistor 40. The potential at connection locus 43 is sufficient to turn on transistors Q4, Q5 in input level setting unit 32 so that potential present at connection locus 53 is applied at input loci 14, 16.

Preferably the potential present at connection locus 53 is substantially equal to the operating potential of amplifier 12. By such an arrangement, when amplifier 12 is returned from a not-on state, potential at input loci 14, 16 will experience little or no excursion or deviation, and noise or pops will thereby be significantly reduced or eliminated.

As mentioned earlier herein, amplifier 12 may have a relatively large input bias current at input loci 14, 16. In such a situation it is advantageous to establish resistors 52, 54 at lower values in voltage divider circuit 55. This is so that the input bias current I_{IN1} at input locus 14 and the input bias current I_{IN2} at input locus 16 have as little effect as possible on the operating voltage (V_{CC} less voltage drop across resistor 52) developed by voltage divider circuit 55. Voltage at input loci 14, 16 (V_{IN}) will be determined by the expression:

$${V}_{IN} = \frac{{R}_{2}}{{R}_{1} + {R}_{2}} \cdot {V}_{CC} \qquad [ 1 ]$$

Where R₁ is the value of resistor 52; and
   R₂ is the value of resistor 54.

Input voltage V_{IN} will be substantially set by parameters associated with operation of amplifier 12. It is desired that current I_{X} through voltage divider circuit 55 be much greater (preferably on the order of ten times greater) than each of input currents I_{IN1}, I_{IN2}. Using resistors 52, 54 whose total series value too great is unwise because the operating voltage will get pulled around by the input bias current of the device itself. However, using too low a resistive value can result in high current through voltage divider circuit 55 which can generate unwanted heat.

When amplifier 12 is placed in a not-on or standby state and state controlling signal STATE goes low, thereby turning off transistor Q1 and permitting potential at connection locus 43 to rise, the potential at connection locus 43 is also sufficient to turn on transistors Q2, Q3 in output level setting unit 34 so that output loci 18, 20 are coupled with ground 49. Grounding output loci 18, 20 eliminates the signal spikes (and the pops manifesting those signal excursions) that may occur at output loci 18, 20 when placing amplifier 12 into a not-on state.

When amplifier 12 is placed in an on state, state controlling signal STATE goes high, thereby turning on transistor Q1. When transistor Q1 is turned on, connection locus 43 is substantially coupled with ground 49 and potential at connection locus 43 approaches zero (i.e., ground). As a consequence, transistors Q4, Q5 are turned off and potential from connection locus 53 is no longer applied to input loci 14, 16. The only signals appearing at input loci 14, 16 are input signals IN₁, IN₂.

Substantially grounding connection locus 43 by turning on transistor Q1 also presents a low signal on line 72. However, RC time constant circuits 83, 85 prevent immediate turning off of transistors Q2, Q3 for a predetermined time interval. Delaying the disconnection of output loci 18, 20 from ground 49 permits output signals OUT₁, OUT₂ to rise somewhat gradually, thereby avoiding large short-term signal excursions which would be manifested as pops in speakers 26, 28.

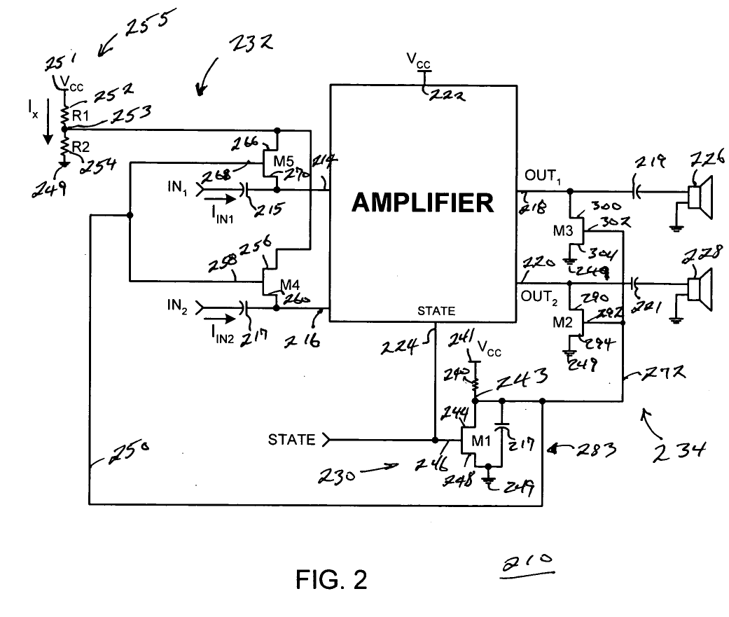

FIG. 2 is an electrical schematic diagram of an audio amplifier with the apparatus of the present invention installed using metal oxide silicon (MOS) transistor technology. In FIG. 2, a noise or pop reducing apparatus 210 is illustrated installed with an amplifier 212. Amplifier 212 is an audio amplifier in this exemplary description of the apparatus of the present invention. Amplifier 212 has a plurality of connection loci, all of which are not shown in FIG. 2. Only those connection loci of amplifier 212 that pertain to explaining the present invention are illustrated in FIG. 2. Amplifier 212 has an input locus 214 at which is received a first input signal IN₁ and has an input locus 216 at which is received a second input signal IN₂. Amplifier 212 has an output locus 218 at which is presented a first output signal OUT₁ and has an output locus 220 at which is presented a second output signal OUT₂. Amplifier 212 has a voltage supply locus 222 at which is received a supply voltage V_{CC}, and amplifier 212 has a state controlling signal locus 224 at which is received a state controlling signal STATE.

Apparatus 210 includes a state sensing circuit 230, an input level setting unit 232 and an output level setting unit 234. State sensing circuit 230 includes an NMOS (n-channel metal oxide silicon) transistor M1, a capacitor 247 and a resistor 240. Transistor M1 has a source 244, a gate 246 and a drain 248. Resistor 240 is coupled between a supply voltage locus 241 and source 244. Capacitor 247 is coupled between source 244 and ground 249. Gate 246 is coupled with state controlling signal locus 224. Drain 248 is coupled with ground 249. Supply voltage V_{CC} is provided at supply voltage locus 241.

Input level setting unit 232 is coupled via a line 250 with state sensing circuit 230 at a connection locus 243 between resistor 240 and source 244. Input level setting unit 232 includes resistors 252, 254 and NMOS (n-channel metal oxide silicon) transistors M4, M5. Transistor M4 has a source 256, a gate 258 and a drain 260. Transistor M5 has a source 266, a gate 268 and a drain 270. Resistors 252, 254 establish a voltage divider circuit 255 between a supply voltage locus 251 and ground 249. Resistor 252 is coupled between supply voltage locus 251 and a connection locus 253. Resistor 254 is coupled between connection locus 253 and ground 249. Supply voltage V_{CC} is provided at supply voltage locus 251. Sources 256, 266 are coupled with connection locus 253. Drain 260 is coupled with input locus 216. Drain 270 is coupled with input locus 214. Gates 258, 268 are coupled with connection locus 243 via line 250. Capacitors 215, 217 serve as DC (direct current) blockers for signals applied at input loci 214, 216.

Output level setting unit 234 is coupled via a line 272 with state sensing circuit 230 at connection locus 243. Output level setting unit 234 includes NMOS (n-channel metal oxide silicon) transistors M2, M3. Transistor M2 has a source 290, a gate 292 and a drain 294. Transistor M3 has a source 300, a gate 302 and a drain 304. Resistor 240 and capacitor 247 coupled among supply voltage locus 241, connection locus 243 and ground 249 establish an RC (resistor-capacitor) time constant circuit 283 that delays signal changes at connection locus 243 from arriving at gates 292, 302 for a predetermined time interval.

Drains 294, 304 are coupled with ground 249. Source 290 is coupled with output locus 220. Source 300 is coupled with output locus 218. Gates 292, 302 are coupled with connection locus 243 via RC time constant circuit 283 and line 272. Capacitors 219, 221 serve as DC (direct current) blockers for signals provided to speakers 226, 228.

When amplifier 212 is placed in a not-on or standby state, state controlling signal STATE goes low, thereby gating off transistor M1. Gating off transistor M1 disconnects connection locus 243 from ground 249 and permits potential at connection locus 243 to rise to a voltage substantially equal with V_{CC} less a voltage drop across resistor 240. The potential at connection locus 243 is sufficient to gate transistors M4, M5 in input level setting unit 232 so that potential present at connection locus 253 is applied at input loci 214, 216.

Preferably the potential present at connection locus 253 is substantially equal to the operating potential of amplifier 212. By such an arrangement, when amplifier 212 is returned from a not-on state, potential at input loci 214, 216 will experience little or no excursion or deviation, and noise or pops will thereby be significantly reduced or eliminated.

As mentioned earlier herein, amplifier 212 may have a relatively large input bias current at input loci 214, 216. In such a situation it is advantageous to establish resistors 252, 254 at lower values in voltage divider circuit 255. This is so that the input bias current I_{IN1} at input locus 214 and the input bias current I_{IN2} at input locus 216 have as little effect as possible on the operating voltage (V_{CC} less voltage drop across resistor 252) developed by voltage divider circuit 255. Voltage at input loci 214, 216 (V_{IN}) will be determined by the expression:

$${V}_{IN} = \frac{{R}_{2}}{{R}_{1} + {R}_{2}} ∘ {V}_{CC} \qquad [ 1 ]$$

Where R₁ is the value of resistor 252; and
   R₂ is the value of resistor 254.

Input voltage V_{IN} will be substantially set by parameters associated with operation of amplifier 212. It is desired that current I_{X} through voltage divider circuit 255 be much greater (preferably on the order of ten times greater) than each of input currents I_{IN1}, I_{IN2}. Using resistors 252, 254 whose total series value too great is unwise because the operating voltage will get pulled around by the device itself. However, using too low a resistive value can result in high current through voltage divider circuit 255 which can generate unwanted heat.

When amplifier 212 is placed in a not-on or standby state and state controlling signal STATE goes low, thereby gating off transistor M1 and permitting potential at connection locus 243 to rise, the potential at connection locus 243 is also sufficient to gate transistors M2, M3 in output level setting unit 234 so that output loci 218, 220 are coupled with ground 249. Grounding output loci 218, 220 eliminates the signal spikes (and the pops manifesting those signal excursions) that may occur at output loci 218, 220 when placing amplifier 212 into a not-on state.

When amplifier is placed in an on state, state controlling signal STATE goes high, thereby gating transistor M1. When transistor M1 is gated, connection locus 243 is substantially coupled with ground 249 and potential at connection locus 243 approaches zero (i.e., ground). As a consequence, transistors M4, M5 are gated off and potential from connection locus 253 is no longer applied to input loci 214, 216. The only signals appearing at input loci 214, 216 are input signals IN₁, IN₂.

Substantially grounding connection locus 243 by gating transistor M1 also presents a low signal on line 272. However, RC time constant circuit 283 prevents immediate gating off of transistors M2, M3 for a predetermined time interval. Delaying the disconnection of output loci 218, 220 from ground 249 permits output signals OUT₁, OUT₂ to rise somewhat gradually, thereby avoiding large short-term signal excursions which would be manifested as pops in speakers 226, 228.

A significant advantage of the apparatus of the present invention is that it is fashioned entirely externally of the amplifier with which it is employed. No redesign of the amplifier device itself is necessary. Moreover, the components required to create the apparatus (e.g., apparatuses 10, 210; FIGS. 1, 2) are commonly available and inexpensive.

The apparatus and method of the present invention may be advantageously employed with virtually any electrical amplifier including, by way of example and not by way of limitation, monaural or stereo audio amplifiers, amplifiers having single ended input or differential inputs, amplifiers having single ended or bridge-tied outputs and amplifiers having any number of inputs and outputs. Employment of the apparatus of the present invention with various types of amplifiers will affect the component count in building the apparatus, but the design of the apparatus is flexible in its amenability for conforming to an individual amplifier device for effective operation.

FIG. 3 is an electrical schematic diagram of a signal amplifier with the apparatus of the present invention installed using bipolar junction transistor technology. In FIG. 3, connections for various transistors are similar to connections described in detail in connection with FIG. 1. In the interest of avoiding prolixity, details ascertainable from FIG. 1 will generally not be repeated here in connection with describing FIG. 3. In FIG. 3, a noise reducing apparatus 410 is illustrated installed with a signal amplifier 412. Amplifier 412 has a plurality of connection loci, all of which are not shown in FIG. 3. Only those connection loci of amplifier 412 that pertain to explaining the present invention are illustrated in FIG. 3. Amplifier 412 has input loci 414₁, 414₂, 414₃, 414ₙ at which are received first input signals IN₁₁, IN₂₁, IN₃₁, INₙ₁. Amplifier 412 also has input loci 416₁, 416₂, 416₃, 416ₙ at which are received second input signals IN₁₂, IN₂₂, IN₃₂, INₙ₂. Amplifier 412 has output loci 418₁, 418₂, 418₃, 418ₙ at which are presented first output signals OUT₁₁, OUT₂₁, OUT₃₁, OUTₙ₁. Amplifier 412 also has output loci 420₁, 420₂, 420₃, 420ₙ at which are presented second output signals OUT₁₂, OUT₂₂, OUT₃₂, OUTₙ₂. Amplifier 412 has a voltage supply locus 422 at which is received a supply voltage V_{CC}, and amplifier 412 has a state controlling signal locus 424 at which is received a state controlling signal STATE.

Apparatus 410 includes a state sensing circuit 430, an input level setting unit 432 and an output level setting unit 434. State sensing circuit 430 includes an NPN bipolar transistor Q1 and resistors 440, 442. Resistor 440 is coupled between a supply voltage locus 441 and transistor Q1. Resistor 442 is coupled between transistor Q1 and state controlling signal locus 24. Transistor Q1 is coupled between resistor 440 and ground 449. Supply voltage V_{CC} is provided at supply voltage locus 441.

Input level setting unit 432 is coupled via a line 450 with state sensing circuit 430 at a connection locus 443 between resistor 440 and transistor Q1. Input level setting unit 432 includes resistors 452, 454, NPN bipolar transistors Q4₁, Q4₂, Q4₃, Q4ₙ and NPN bipolar transistors Q5₁, Q5₂, Q5₃, Q5ₙ. Resistors 452, 454 establish a voltage divider circuit 455 between a supply voltage locus 451 and ground 449. Resistor 452 is coupled between supply voltage locus 451 and a connection locus 453. Resistor 454 is coupled between connection locus 453 and ground 449. Supply voltage V_{CC} is provided at supply voltage locus 451.

Transistors Q4₁, Q4₂, Q4₃, Q4ₙ are coupled between connection locus 453 and respective input loci 416₁, 416₂, 416₃, 416ₙ. Transistors Q5₁, Q5₂, Q5₃, Q5ₙ are coupled between connection locus 453 and respective input loci 414₁, 414₂, 414₃, 414ₙ. Capacitors used as DC (direct current) blockers for signals applied at input loci 414ₙ, 416ₙ have been left out of FIG. 3 in the interest of simplifying the drawing.

Output level setting unit 434 is coupled via a line 472 with state sensing circuit 430 at connection locus 443. Output level setting unit 434 includes resistors 482₁, 482₂, 482₃, 482ₙ, resistors 484₁, 484₂, 484₃, 484ₙ, capacitors 486₁, 486₂, 486₃, 486ₙ, capacitors 488₁, 488₂, 484₃, 488ₙ, NPN bipolar transistors Q2₁, Q2₂, Q2₃, Q2ₙ and NPN bipolar transistors Q3₁, Q3₂, Q3₃, Q3ₙ. Transistors Q2₁, Q2₂, Q2₃, Q2ₙ are coupled between ground 449 and respective output loci 420₁, 420₂, 420₃, 420ₙ. Transistors Q3₁, Q3₂, Q3₃, Q3ₙ are coupled between ground 449 and respective output loci 418₁, 418₂, 418₃, 418ₙ.

Resistors 482₁, 482₂, 482₃, 482ₙ and capacitors 486₁, 486₂, 486₃, 486ₙ are coupled among connection locus 443, transistors Q2₁, Q2₂, Q2₃, Q2ₙ and ground 449 to establish RC (resistor-capacitor) time constant circuits 483₁, 483₂, 483₃, 483ₙ that delay signal changes at connection locus 443 from arriving at transistors Q2₁, Q2₂, Q2₃, Q2ₙ for a predetermined time interval. Resistors 484₁, 484₂, 484₃, 484ₙ and capacitors 488₁, 488₂, 488₃, 488ₙ are coupled among connection locus 443, transistors Q3₁, Q3₂, Q3₃, Q3ₙ and ground 449 to establish RC (resistor-capacitor) time constant circuits 485₁, 485₂, 485₃, 485ₙ that delay signal changes at connection locus 443 from arriving at transistors Q3₁, Q3₂, Q3₃, Q3ₙ for a predetermined time interval. Capacitors used as DC (direct current) blockers for signals provided at output loci 418ₙ, 420ₙ have been left out of FIG. 3 in the interest of simplifying the drawing.

When amplifier 412 is placed in a not-on or standby state, state controlling signal STATE goes low, thereby turning off transistor Q1. Turning off transistor Q1 disconnects connection locus 443 from ground 449 and permits potential at connection locus 443 to rise to a voltage substantially equal with V_{CC} less a voltage drop across resistor 440. The potential at connection locus 443 is sufficient to turn on respective transistors Q4ₙ, Q5ₙ in input level setting unit 432 so that potential present at connection locus 453 is applied at respective input loci 414ₙ, 416ₙ.

Preferably the potential present at connection locus 453 is substantially equal to the operating potential of amplifier 412. By such an arrangement, when amplifier 412 is returned from a not-on state, potential at respective input loci 414ₙ, 416ₙ will experience little or no excursion or deviation, and noise will thereby be significantly reduced or eliminated.

As mentioned earlier herein, amplifier 412 may have a relatively large input bias current at respective input loci 414ₙ, 416ₙ. In such a situation it is advantageous to establish resistors 452, 454 at lower values in voltage divider circuit 455. This is so for the same reasons as were discussed earlier herein in connection with FIG. 1. Design considerations connected with expression [1] are as pertinent in the context of apparatus 410 (FIG. 3) as they are in connection with apparatus 10 (FIG. 1). Accordingly, to avoid prolixity, this aspect of apparatus 410 will not be further discussed or described here.

When amplifier 412 is placed in a not-on or standby state and state controlling signal STATE goes low, thereby turning off transistor Q1 and permitting potential at connection locus 443 to rise, the potential at connection locus 443 is also sufficient to turn on respective transistors Q2ₙ, Q3ₙ in output level setting unit 434 so that output loci 418, 420 are coupled with ground 449. Grounding respective output loci 418ₙ, 420ₙ eliminates signal spikes that may occur at respective output loci 418ₙ, 420ₙ when placing amplifier 412 into a not-on state.

When amplifier 412 is placed in an on state, state controlling signal STATE goes high, thereby turning on transistor Q1. When transistor Q1 is turned on, connection locus 443 is substantially coupled with ground 449 and potential at connection locus 443 approaches zero (i.e., ground). As a consequence, respective transistors Q4ₙ, Q5ₙ are turned off and potential from connection locus 453 is no longer applied to respective input loci 414ₙ, 416ₙ. The only signals appearing at respective input loci 414ₙ, 416ₙ are respective input signals INₙ₁, INₙ₂.

Substantially grounding connection locus 443 by turning on transistor Q1 also presents a low signal on line 472. However, respective RC time constant circuits 483ₙ, 485ₙ prevent immediate turning off of respective transistors Q2ₙ, Q3ₙ for a predetermined time interval. Delaying the disconnection of respective output loci 418ₙ, 420ₙ from ground 449 permits respective output signals OUTₙ₁, OUTₙ₂ to rise somewhat gradually, thereby avoiding large short-term signal excursions which would be manifested as noise at respective output loci 418ₙ, 420ₙ.

Throughout this disclosure, the indicators “n” or “m” are employed to signify that there can be any number of particular signals or circuit elements in an illustrated apparatus or amplifier device. The inclusion of a particular number of signals or circuit elements (e.g., first input signals INₙₘ or transistors Q2ₙ, Q3ₙ) in FIG. 3 is illustrative only and does not constitute any limitation regarding the number of signals or circuit elements that may be included in the apparatus of the present invention.

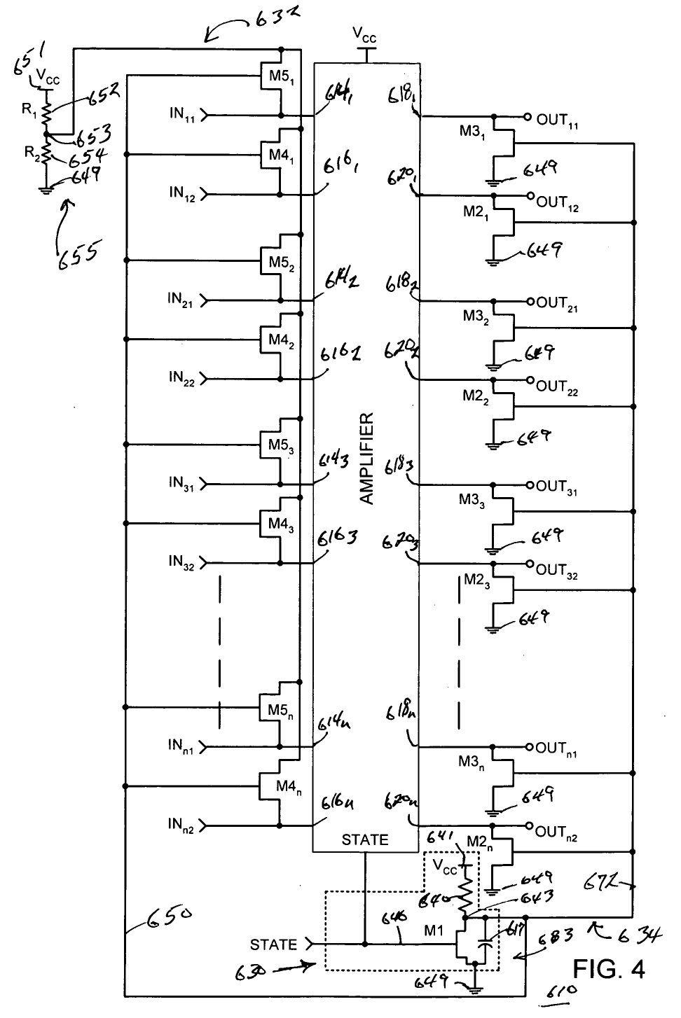

FIG. 4 is an electrical schematic diagram of a signal amplifier with the apparatus of the present invention installed using metal oxide silicon (MOS) transistor technology. In FIG. 4, a noise reducing apparatus 610 is illustrated installed with an amplifier 612. Amplifier 612 has a plurality of connection loci, all of which are not shown in FIG. 4. Only those connection loci of amplifier 612 that pertain to explaining the present invention are illustrated in FIG. 4. Amplifier 612 has input loci 614₁, 614₂, 614₃, 614ₙ at which are received first input signals IN₁₁, IN₂₁, IN₃₁, INₙ. Amplifier 612 has input loci 616₁, 616₂, 616₃, 616ₙ at which are received second input signals IN₁₂, IN₂₂, IN₃₂, INₙ₂. Amplifier 612 has output loci 618 at which are presented first output signals OUT₁₁, OUT₂₁, OUT₃₁, OUTₙ₁. Amplifier 612 has output loci 620 at which are presented second output signals OUT₁₂, OUT₂₂, OUT₃₂, OUTₙ₂ Amplifier 612 has a voltage supply locus 622 at which is received a supply voltage V_{CC}, and amplifier 612 has a state controlling signal locus 624 at which is received a state controlling signal STATE.

Apparatus 610 includes a state sensing circuit 630, an input level setting unit 632 and an output level setting unit 634. State sensing circuit 630 includes an NMOS (n-channel metal oxide silicon) transistor M1, a capacitor 647 and a resistor 640. Resistor 640 is coupled between a supply voltage locus 641 and transistor M1. Capacitor 647 is coupled with a connection locus 643 between resistor 640 and transistor M1, and capacitor 647 is coupled with ground 649. Transistor M1 is connected with state controlling signal locus 624 by its gate 646. Supply voltage V_{CC} is provided at supply voltage locus 641.

Input level setting unit 632 is coupled via a line 650 with state sensing circuit 630 at connection locus 643. Input level setting unit 632 includes resistors 652, 654, NMOS (n-channel metal oxide silicon) transistors M4₁, M4₂, M4₃, M4ₙ and NMOS transistors M5₁, M5₂, M5₃, M5ₙ. Resistors 652, 654 establish a voltage divider circuit 655 between a supply voltage locus 651 and ground 649. Resistor 652 is coupled between supply voltage locus 651 and a connection locus 653. Resistor 654 is coupled between connection locus 653 and ground 649. Supply voltage V_{CC} is provided at supply voltage locus 651.

Transistors M4₁, M4₂, M4₃, M4ₙ are coupled between connection locus 653 and respective input loci 616₁, 616₂, 616₃, 616ₙ. Transistors M5₁, M5₂, M5₃, M5ₙ are coupled between connection locus 653 and respective input loci 614₁, 614₂, 614₃, 614ₙ. Capacitors used as DC (direct current) blockers for signals applied at input loci 614ₙ, 616ₙ have been left out of FIG. 4 in the interest of simplifying the drawing.

Output level setting unit 634 is coupled via a line 672 with state sensing circuit 630 at connection locus 643. Output level setting unit 634 includes NMOS (n-channel metal oxide silicon) transistors M2₁, M2₂, M2₃, M2ₙ, and includes NMOS transistors M3₁, M3₂, M3₃, M3ₙ. Transistors M2₁, M2₂, M2₃, M2ₙ are coupled between ground 649 and respective output loci 620₁, 620₂, 620₃, 620ₙ. Transistors M3₁, M3₂, M3₃, M3ₙ are coupled between ground 649 and respective output loci 618₁, 618₂, 618₃, 618ₙ.

Resistor 640 and capacitor 647 coupled among supply voltage locus 641, connection locus 643 and ground 649 establish an RC (resistor-capacitor) time constant circuit 683 that delays signal changes at connection locus 643 from arriving at gates of respective transistors M2ₙ, M3ₙ for a predetermined time interval. Capacitors used as DC (direct current) blockers for signals provided at output loci 618ₙ, 620ₙ have been left out of FIG. 4 in the interest of simplifying the drawing.

When amplifier 612 is placed in a not-on or standby state, state controlling signal STATE goes low, thereby gating off transistor M1. Gating off transistor M1 disconnects connection locus 643 from ground 649 and permits potential at connection locus 643 to rise to a voltage substantially equal with V_{CC} less a voltage drop across resistor 640. The potential at connection locus 643 is sufficient to gate respective transistors M4ₙ, M5ₙ in input level setting unit 632 so that potential present at connection locus 653 is applied at respective input loci 614ₙ, 616ₙ.

Preferably the potential present at connection locus 653 is substantially equal to the operating potential of amplifier 612. By such an arrangement, when amplifier 612 is returned from a not-on state, potential at respective input loci 614ₙ, 616ₙ will experience little or no excursion or deviation, and noise will thereby be significantly reduced or eliminated.

As mentioned earlier herein, amplifier 612 may have a relatively large input bias current at respective input loci 614ₙ, 616ₙ. In such a situation it is advantageous to establish resistors 652, 654 at lower values in voltage divider circuit 655. This is so for the same reasons as were discussed earlier herein in connection with FIG. 2. Design considerations connected with expression [1] are as pertinent in the context of apparatus 610 (FIG. 4) as they are in connection with apparatus 210 (FIG. 2). Accordingly, to avoid prolixity, this aspect of apparatus 610 will not be further discussed or described here.

When amplifier 612 is placed in a not-on or standby state and state controlling signal STATE goes low, thereby gating off transistor M1 and permitting potential at connection locus 643 to rise, the potential at connection locus 643 is also sufficient to gate respective transistors M2ₙ, M3ₙ in output level setting unit 634 so that respective output loci 618₁, 620ₙ are coupled with ground 649. Grounding respective output loci 618ₙ, 620ₙ eliminates the signal spikes that may occur at respective output loci 618ₙ, 620ₙ when placing amplifier 612 into a not-on state.

When amplifier is placed in an on state, state controlling signal STATE goes high, thereby gating transistor M1. When transistor M1 is gated, connection locus 643 is substantially coupled with ground 649 and potential at connection locus 643 approaches zero (i.e., ground). As a consequence, respective transistors M4ₙ, M5ₙ are gated off and potential from connection locus 653 is no longer applied to respective input loci 614ₙ, 616ₙ. The only signals appearing at respective input loci 614ₙ, 616ₙ are respective input signals INₙ₁, INₙ₂.

Substantially grounding connection locus 643 by gating transistor M1 also presents a low signal on line 672. However, RC time constant circuit 683 prevents immediate gating off of respective transistors M2ₙ, M3ₙ for a predetermined time interval. Delaying the disconnection of respective output loci 618ₙ, 620ₙ from ground 649 permits respective output signals OUTₙ₁, OUTₙ₂ to rise somewhat gradually, thereby avoiding large short-term signal excursions which would be manifested as noise.

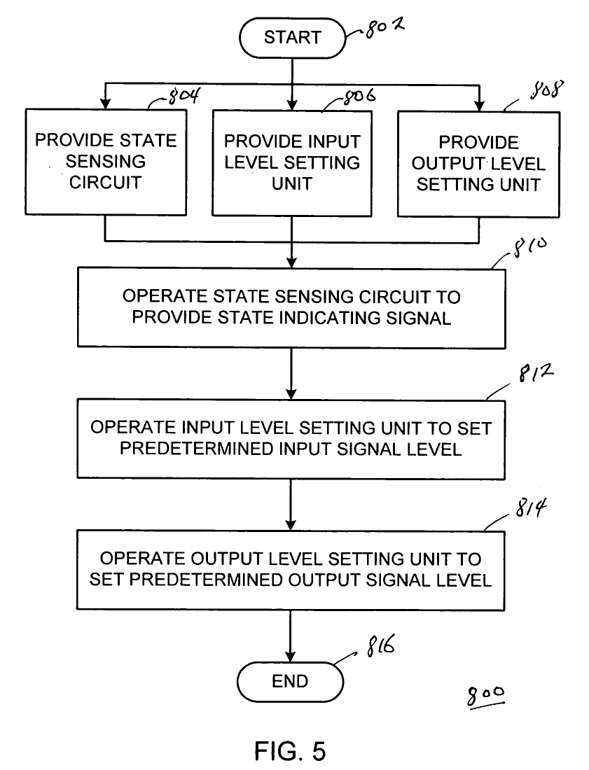

FIG. 5 is a flow chart illustrating the method of the present invention. In FIG. 5, a method 800 for reducing audio popping noises from an audio amplifier device when the audio amplifier device changes state between an on state and an other state begins at a START locus 802. The audio amplifier has at least one input locus, at least one output locus and a state signal locus. The audio amplifier device changes state in response to a state controlling signal received at the state signal locus. The audio amplifier device has an operating voltage provided at the at least one input locus when in the on state. The method includes the steps of: (a) In no particular order: (1) providing a state sensing circuit coupled with the state signal locus, as indicated by a block 804; (2) providing an input level setting unit coupled with the state sensing circuit and with at least one selected input locus of the at least one input locus, as indicated by a block 806; and (3) providing an output level setting unit coupled with at least one selected output locus of the at least one output locus, as indicated by a block 808.

Method 800 continues with the step of (b) operating the state sensing circuit to provide a state indicating signal in response to the state controlling signal, as indicated by a block 810. Method 800 continues with the step of (c) operating the input level setting unit to set a predetermined input signal level at the at least one selected input locus in response to the state indicating signal when the audio amplifier device changes from the on state to the other state, as indicated by a block 812.

Method 800 continues with the step of (d) operating the output level setting unit to set a predetermined output signal level at the at least one selected output locus in response to the state indicating signal when the audio amplifier device changes from the on state to the other state, as indicated by a block 814. Method 800 terminates at an END block 816.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus for controlling sudden audio output signals from an audio amplifier device when changing state of said audio amplifier device; said audio amplifier having at least one input locus, at least one output locus and a state controlling signal locus; said audio amplifier device changing state in response to a state controlling signal received at said state controlling signal locus; the apparatus comprising:
(a) a state sensing circuit coupled with said state controlling signal locus; said state sensing circuit providing a state indicating signal in response to said state controlling signal;
(b) an input level setting unit coupled with said state sensing circuit and with at least one selected input locus of said at least one input locus; said input level setting unit setting a predetermined first input signal level at said at least one selected input locus in response to said state indicating signal when said audio amplifier device changes from a first state to a second state; and
(c) an output level setting unit coupled with at least one selected output locus of said at least one output locus; said output level setting unit setting a predetermined first output signal level at said at least one selected output locus in response to said state indicating signal when said audio amplifier device changes from said first state to said second state.

2. An apparatus for controlling sudden audio output signals from an audio amplifier device when changing state of said audio amplifier device as recited in claim 1 wherein said input level setting unit sets a predetermined second input signal level at said at least one selected input locus in response to said state indicating signal when said audio amplifier device changes from said second state to said first state.

3. An apparatus for controlling sudden audio output signals from an audio amplifier device when changing state of said audio amplifier device as recited in claim 1 wherein said output level setting unit sets a predetermined second output signal level at said at least one selected output locus in response to said state indicating signal when said audio amplifier device changes from said second state to said first state.

4. An apparatus for controlling sudden audio output signals from an audio amplifier device when changing state of said audio amplifier device as recited in claim 2 wherein said output level setting unit sets a predetermined second output signal level at said at least one selected output locus in response to said state indicating signal when said audio amplifier device changes from said second state to said first state.

5. An apparatus for controlling sudden audio output signals from an audio amplifier device when changing state of said audio amplifier device as recited in claim 1 wherein said first state is an on state and wherein said second state is an off state; said first input signal level being generally equal with an operating signal level at said at least one selected input locus when said audio amplifier device is in an on state.

6. An apparatus for controlling sudden audio output signals from an audio amplifier device when changing state of said audio amplifier device as recited in claim 4 wherein said first state is an on state and wherein said second state is an off state; said first input signal level being generally equal with an operating signal level at said at least one selected input locus when said audio amplifier device is in an on state.

7. An apparatus for controlling sudden audio output signals from an audio amplifier device when changing state of said audio amplifier device as recited in claim 1 wherein said first state is an on state and wherein said second state is an off state; said first output signal level being generally at ground when said audio amplifier device is in an off state.

8. An apparatus for controlling sudden audio output signals from an audio amplifier device when changing state of said audio amplifier device as recited in claim 4 wherein said first state is an on state and wherein said second state is an off state; said first output signal level being generally at ground when said audio amplifier device is in an off state.

9. An apparatus for controlling sudden audio output signals from an audio amplifier device when changing state of said audio amplifier device as recited in claim 7 wherein said output level setting unit includes a time delay unit; said time delay unit delaying changing said first output signal level to said second output signal level for a predetermined time when said audio amplifier device changes from said second state to said first state.

10. An apparatus for controlling sudden audio output signals from an audio amplifier device when changing state of said audio amplifier device as recited in claim 8 wherein said output level setting unit includes a time delay unit; said time delay unit delaying changing said first output signal level to said second output signal level for a predetermined time when said audio amplifier device changes from an off state to an on state.

11. An apparatus for reducing audio popping noises from an audio amplifier device when said audio amplifier device changes state between an on state and an other state; said audio amplifier having at least one input locus, at least one output locus and a state signal locus; said audio amplifier device changing state in response to a state controlling signal received at said state signal locus; said audio amplifier device having an operating voltage provided at said at least one input locus when in said on state; the apparatus comprising:
(a) a state sensing circuit coupled with said state signal locus; said state sensing circuit providing a state indicating signal in response to said state controlling signal;
(b) an input level setting unit coupled with said state sensing circuit and with at least one selected input locus of said at least one input locus; said input level setting unit setting a predetermined input signal level at said at least one selected input locus in response to said state indicating signal when said audio amplifier device changes from said on state to said other state; and
(c) an output level setting unit coupled with at least one selected output locus of said at least one output locus; said output level setting unit setting a predetermined output signal level at said at least one selected output locus in response to said state indicating signal when said audio amplifier device changes from said on state to said other state.

12. An apparatus for reducing audio popping noises from an audio amplifier device when said audio amplifier device changes state between an on state and an other state as recited in claim 11 wherein said predetermined input signal level is generally equal with said operating voltage.

13. An apparatus for reducing audio popping noises from an audio amplifier device when said audio amplifier device changes state between an on state and an other state as recited in claim 11 wherein said input level setting circuit is uncoupled from said at least one selected input locus when said audio amplifier device changes state from said other state to said on state

14. An apparatus for reducing audio popping noises from an audio amplifier device when said audio amplifier device changes state between an on state and an other state as recited in claim 12 wherein said input level setting circuit is uncoupled from said at least one selected input locus when said audio amplifier device changes state from said other state to said on state.

15. An apparatus for reducing audio popping noises from an audio amplifier device when said audio amplifier device changes state between an on state and an other state as recited in claim 11 wherein said predetermined output signal level is generally at ground.

16. An apparatus for reducing audio popping noises from an audio amplifier device when said audio amplifier device changes state between an on state and an other state as recited in claim 14 wherein said predetermined output signal level is generally at ground.

17. An apparatus for reducing audio popping noises from an audio amplifier device when said audio amplifier device changes state between an on state and an other state as recited in claim 11 wherein said output level setting unit includes a time delay unit; said time delay unit delaying changing said predetermined output signal level for a predetermined time after said audio amplifier device changes from said other state to said on state.

18. An apparatus for reducing audio popping noises from an audio amplifier device when said audio amplifier device changes state between an on state and an other state as recited in claim 16 wherein said output level setting unit includes a time delay unit; said time delay unit delaying changing said predetermined output signal level for a predetermined time after said audio amplifier device changes from said other state to said on state.

19. A method for reducing audio popping noises from an audio amplifier device when said audio amplifier device changes state between an on state and an other state; said audio amplifier having at least one input locus, at least one output locus and a state signal locus; said audio amplifier device changing state in response to a state controlling signal received at said state signal locus; said audio amplifier device having an operating voltage provided at said at least one input locus when in said on state; the method comprising the steps of:
(a) In no particular order:
(1) providing a state sensing circuit coupled with said state signal locus;
(2) providing an input level setting unit coupled with said state sensing circuit and with at least one selected input locus of said at least one input locus; and
(3) providing an output level setting unit coupled with at least one selected output locus of said at least one output locus;
(b) operating said state sensing circuit to provide a state indicating signal in response to said state controlling signal;
(c) operating said input level setting unit to set a predetermined input signal level at said at least one selected input locus in response to said state indicating signal when said audio amplifier device changes from said on state to said other state; and
(d) operating said output level setting unit to set a predetermined output signal level at said at least one selected output locus in response to said state indicating signal when said audio amplifier device changes from said on state to said other state.

20. A method for reducing audio popping noises from an audio amplifier device when said audio amplifier device changes state between an on state and an other state as recited in claim 19 wherein said predetermined input signal level is generally equal with said operating voltage, and wherein said predetermined output signal level is generally at ground.
